(19) United States
(12) Patent Application Publication
(10) Pub. No.: US 2013/0076986 A1
(43) Pub. Date: Mar. 28, 2013

(54) BATTERYLESS DIGITAL TELEVISION RECEIVER

(71) Applicant: Hsin-Yu CHEN, Taipei City (TW)

(72) Inventor: Hsin-Yu CHEN, Taipei City (TW)

(73) Assignee: DEXATEK TECHNOLOGY LTD

(21) Appl. No.: 13/241,889

(22) Filed: Sep. 23, 2011

(51) Int. Cl. H04N 5/63

(52) U.S. Cl. 348/730; 348/E05.127

(57) ABSTRACT

A batteryless digital TV receiver has a connector mounted on a body and complying with a specific standard, an RF receiving module, a digital TV processor, an authentication chip and a switching power conversion module. When the batteryless digital TV receiver is connected with a handheld device, the switching power conversion module acquires power outputted from the handheld device through the connector, limits an operating power under a specific current, supplies the operating power to the RF receiving module, the digital TV processor and the authentication chip. After the authentication chip and the handheld device finish an authentication step, the digital TV processor receives digital TV signals from the RF receiving module. The digital TV signals are decoded and transmitted to the handheld device and are displayed on the handheld device.

### BACKGROUND OF THE INVENTION

1. Field of the Invention

The present invention relates to a digital television (TV) receiver, and more particularly to a batteryless digital television receiver connected to a handheld device to convert digital TV signals to be displayed on the handheld device and receiving power from the handheld device.

2. Description of the Related Art

In recent years, handheld devices have been rapidly developed from early stage notebook computers to current smart cell phones or tablet personal computers. Relevant products associated with those handheld devices also won the favor of consumers. Peripheral devices collaborating with the handheld devices bring forth more convenient and practical functions to users.

To keep abreast with the prevalence of handheld devices, peripheral devices collaborating with handheld devices have become more and more diversified. In view of the overwhelming response to Apple products, such as iPhone, iPad and iPod, the peripheral devices for the foregoing handheld devices also mushroom to emerge in the market. Among the peripheral devices is a receiver for the foregoing handheld devices to receive digital TV signals and display digital TV programs. Such receiver can be connected with a cell phone or a tablet personal computer (PC) and sends received, decoded and encoded digital TV signals to the cell phone or the tablet PC for the cell phone or the tablet PC to play so that users can watch digital TV programs through a cell phone or a tablet PC.

However, as requiring batteries to supply an operating power, the digital TV receiver is relatively large and heavy, takes up a lot of space and is inconvenient when being carried. Under the circumstance, the portability concern may not be an issue if the digital TV receiver can acquire power from a handheld device. However, handheld device manufacturers normally have strict specification requirements concerning the peripheral devices. For example, Apple Inc. imposes strict operating current limitation on peripheral devices, such as current output less than 100 mA. Accordingly, conventional digital TV receivers need to both improve portability and meet the specification requirements of peripheral devices demanded by the handheld device manufacturers.

### SUMMARY OF THE INVENTION

An objective of the present invention is to provide a batteryless digital TV receiver receiving operating power and digital TV signals from a handheld device, decoding and encoding the digital TV signals, and transmitting the digital TV signals to the handheld device to play.

To achieve the foregoing objective, the batteryless digital TV receiver has a body, a connector, an antenna port, a digital TV processor, an RF receiving module, an authentication chip, and a switching power conversion module.

The connector is mounted on the body and has a power input pin and a set of signal access pins.

The antenna port is mounted on the body.

The digital TV processor has at least one power input terminal, one set of signal access terminals, a set of authentication data access terminals, and at least one set of RF signal input terminals. The set of signal access terminals is connected to the set of signal access pins of the connector.

The RF receiving module has at least one set of digital signal input terminals, at least one set of digital signal output terminals and a power input terminal.

The at least one set of digital signal input terminals is connected to the antenna port on the body.

The at least one set of digital signal output terminals is respectively connected to the at least one set of RF signal input terminals of the digital TV processor.

The authentication chip has a set of authentication data access terminals and a power input terminal. The set of authentication data access terminals is connected to the set of authentication data access terminals of the digital TV processor.

The switching power conversion module has at least one power input terminal and multiple power output terminals. The at least one power input terminal is connected to the power input pin of the connector. The power output terminals are respectively connected to the power input terminals of the digital TV processor, the RF receiving module and the authentication chip. The digital TV receiver, the RF receiving module, the authentication chip and the switching power conversion module are mounted inside the body.

The switching power conversion module has a higher voltage conversion efficiency as designed based on a switching power technique. Additionally, the converted voltage has better voltage stability. Accordingly, the power loss is relatively low and thus meets the limitation of the handheld device posted on output current.

Given the batteryless digital TV receiver, users can plug the connector on the body of the batteryless digital TV receiver in a handheld device. The switching power conversion module receives power outputted from the handheld device through the connector and outputs the power to the digital TV processor, the RF receiving module and the authentication chip for their operation. After acquiring an authentication approval from the handheld device through the authentication chip, the digital processor decodes and encodes received digital TV signals and sends the digital TV signals to the handheld device for the handheld device to display the corresponding digital TV programs. The foregoing design allows the digital TV receiver to be operated under a power specification requirement of a handheld device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a batteryless digital TV receiver in accordance with the present invention;

FIG. 2 is a functional block diagram of the batteryless digital TV receiver in FIG. 1;

FIGS. 3A to 3I are divisions of a first partial circuit diagram of the batteryless digital TV receiver in FIG. 2;

FIGS. 4A to 4D are divisions of a second partial circuit diagram of the batteryless digital TV receiver in FIG. 2;

FIG. 5 is a third partial circuit diagram of the batteryless digital TV receiver in FIG. 2; and

FIG. 6 is an operational top view of the batteryless digital TV receiver in FIG. 1.

### DETAILED DESCRIPTION OF THE INVENTION

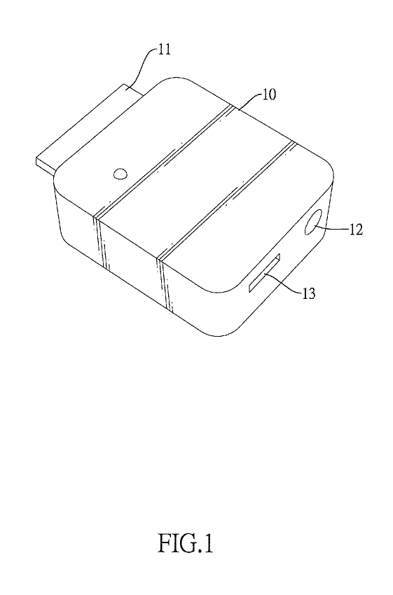

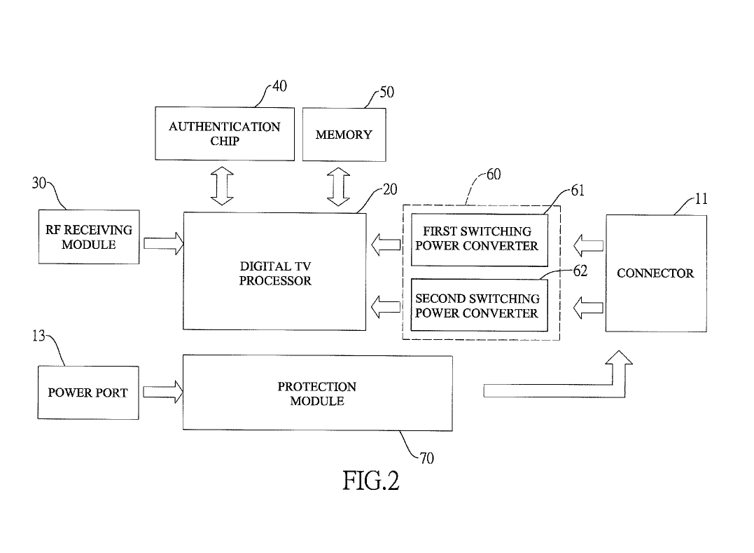

With reference to FIG. 1, a batteryless digital TV receiver in accordance with the present invention has a body 10, a connector 11 and an antenna port 12. The connector 11 and the antenna port 12 are mounted on the body 10. The connector 11 has a power input pin and a set of signal access pins. With reference to FIG. 2, the batteryless digital TV receiver further has a digital TV processor 20, a radio frequency (RF) receiving module 30, an authentication chip 40, a memory 50 and a switching power conversion module 60 mounted inside the body 10.

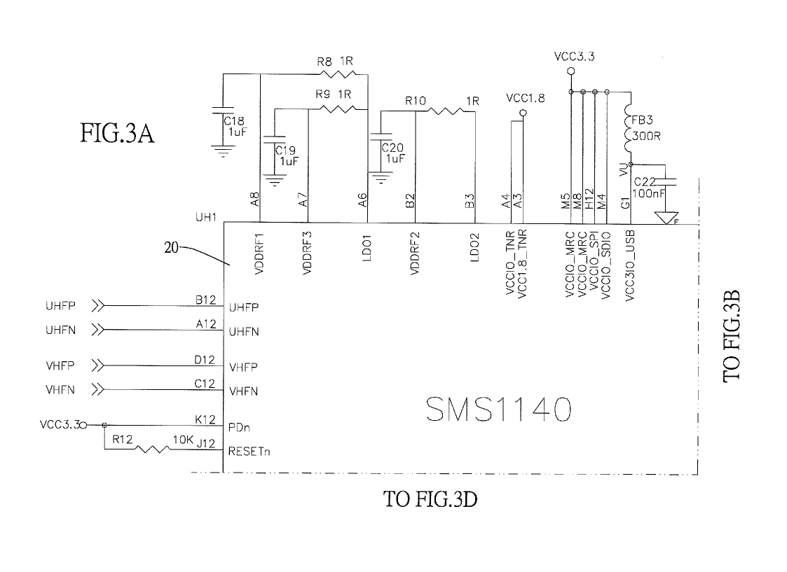

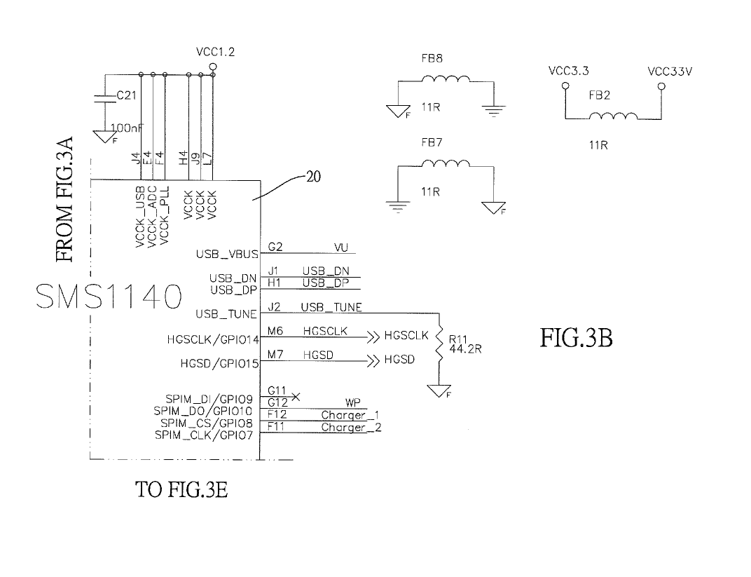

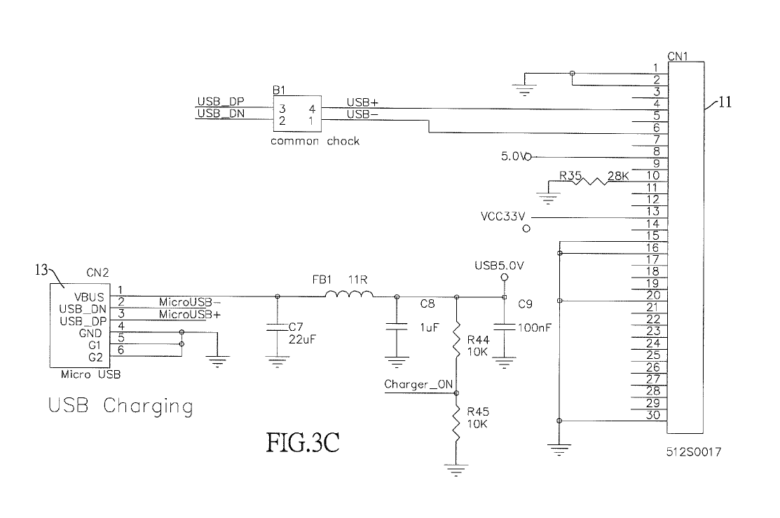

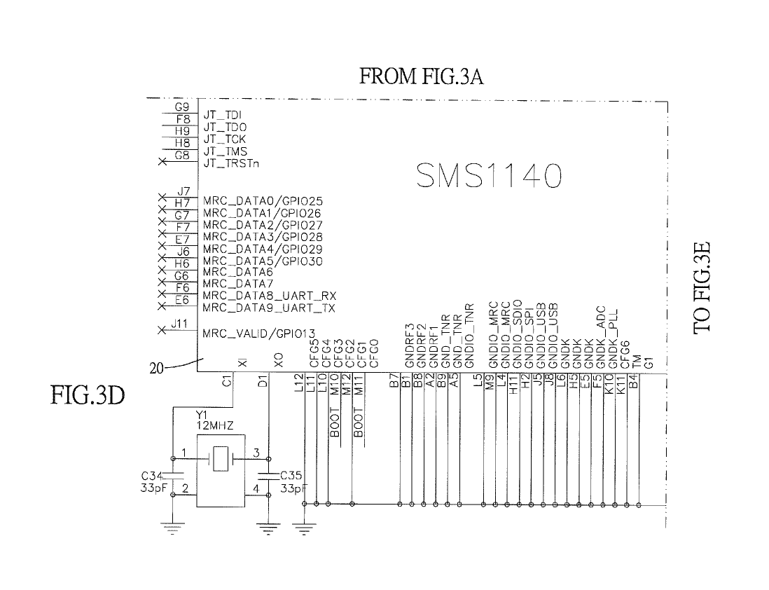

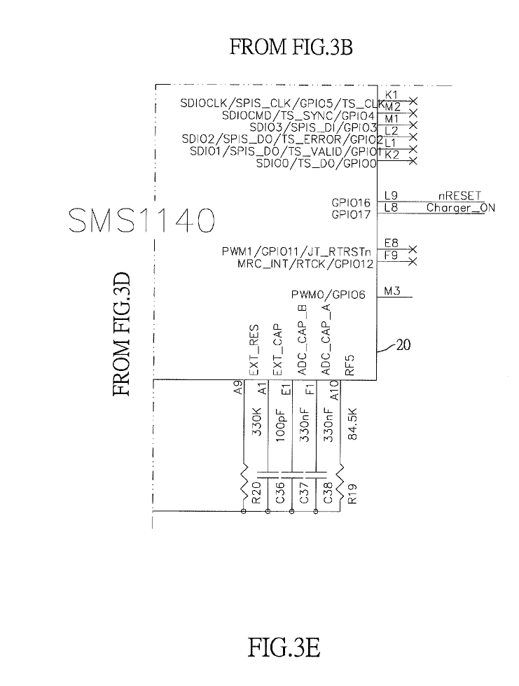

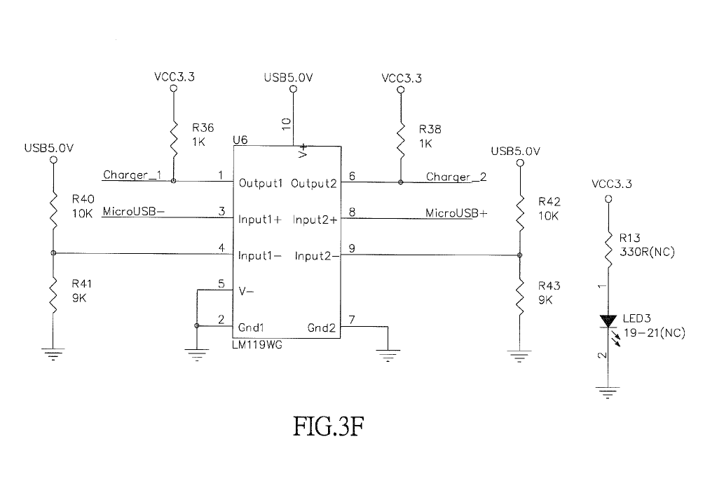

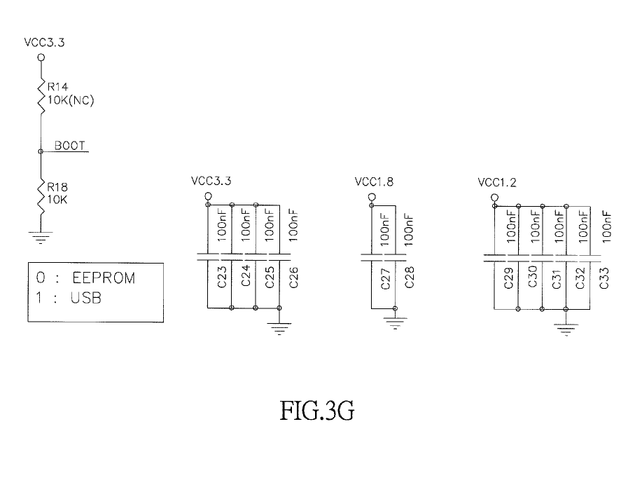

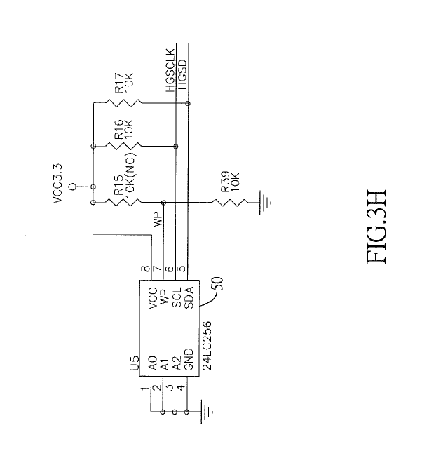

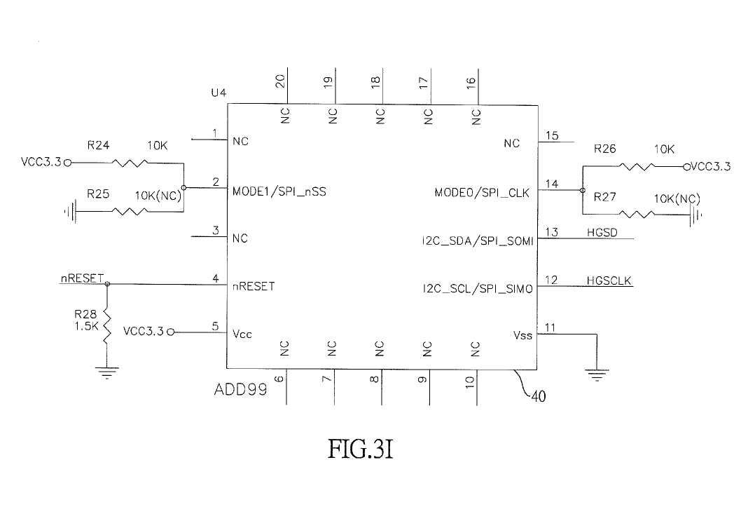

With reference to FIGS. 3A to 3I, an embodiment of the connector on the right side is shown. In the present embodiment, the connector 11 pertains to a 30-pin connector compatible with the I/O interfaces of the smart cell phone iPhone, the tablet PC iPad and the digital player iPod (hereinafter termed as handheld devices) made by Apple. Pin 8 of the connector 11 is a power output pin (5.0V), pin 13 is a power input pin (VCC3.3V), and pins 4 and 6 correspond to the set of signal access pins. The power input pin (VCC3.3V) is connected to the switching power conversion module 60. When the batteryless digital TV receiver is connected with the handheld devices through the connector 11, a 3.3V DC current is acquired from the handheld devices through the power input pin (VCC3.3V).

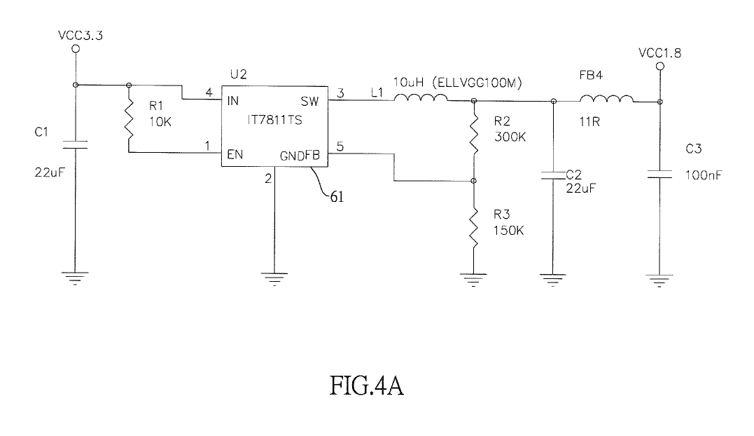

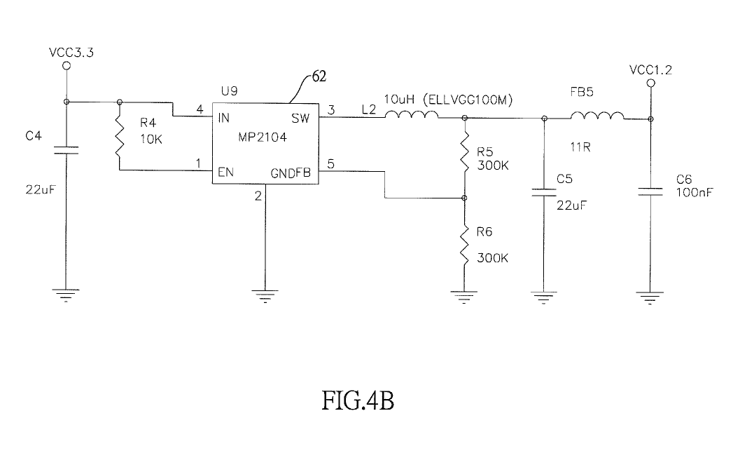

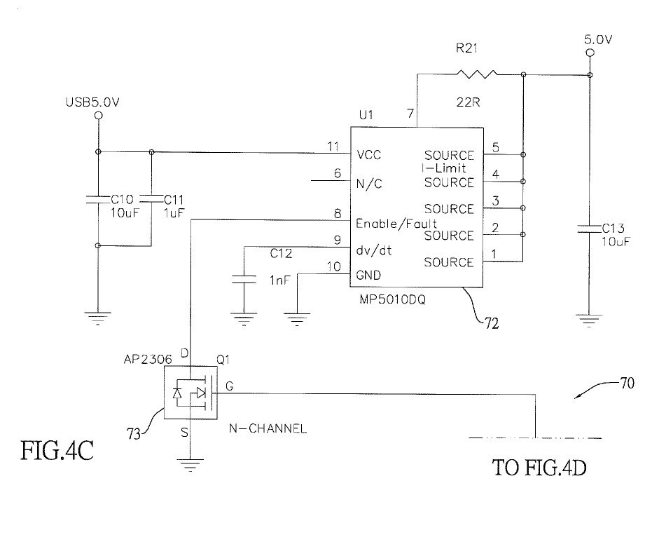

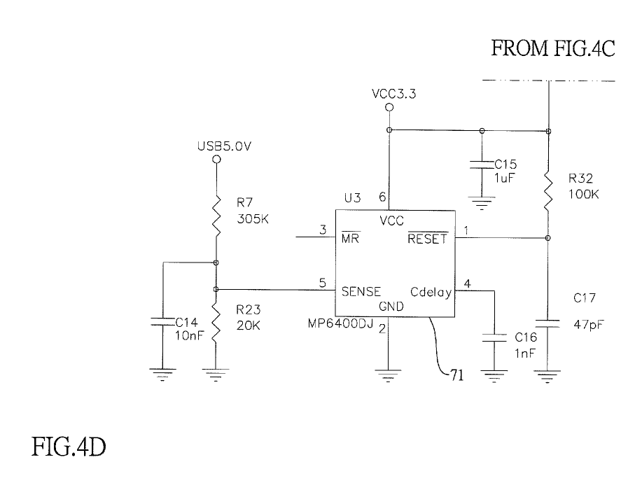

With reference to FIGS. 4A to 4D, the switching power conversion module 60 has a first switching power converter 61 and a second switching power converter 62. The power input terminals (IN) of the first switching power converter 61 and the second switching power converter 62 are connected to the power input pin (VCC3.3V) of the connector 11 to convert and generate 1.8V DC power and 1.2V DC power respectively supplying power to circuits and elements, such as the digital TV processor 20, inside the body 10. As the first switching power converter 61 and the second switching power converter 62 control output voltage with pulse width modulation (PWM) and adjust output voltage through feedback, strict specification requirements regarding output voltage (current), including the requirement for operating current less than 100 mA, can be met.

With further reference to FIG. 3, the digital TV processor 20 serves to convert specific types of digital TV signals. In the present embodiment, the digital TV processor 20 serves to process digital TV signals in compliance with DVB-T and ISDB-T standards. The digital TV processor 20 has two sets of RF signal input terminals (UHFP, UHFN, VHFP, VHFN), one set of signal access terminals (USB_DN, USB_DP) and one set of authentication data access terminals (HGSCLK, HGSD). The two sets of RF signal input terminals (UHFP, UHFN, VHFP, VHFN) serve to receive UHF (Ultra High Frequency) and VHF (Very High Frequency) digital TV signals. The set of signal access terminals (USB_DN, USB_DP) serves to transmit digital TV signals to a handheld device through the connector 11. The set of authentication data access terminals (HGSCLK, HGSD) is connected to the authentication chip 40 and the memory 50.

Each of the authentication chip 40 and the memory 50 has one set of authentication data access terminals (HGSCLK, HGSD) and a power input terminal (VCC3.3V). The set of authentication data access terminals (HGSCLK, HGSD) is connected to the set of authentication data access terminals (HGSCLK, HGSD) of the digital TV processor 20. The power input terminal (VCC3.3V) is connected to the power input terminal (VCC3.3V) of the connector 11.

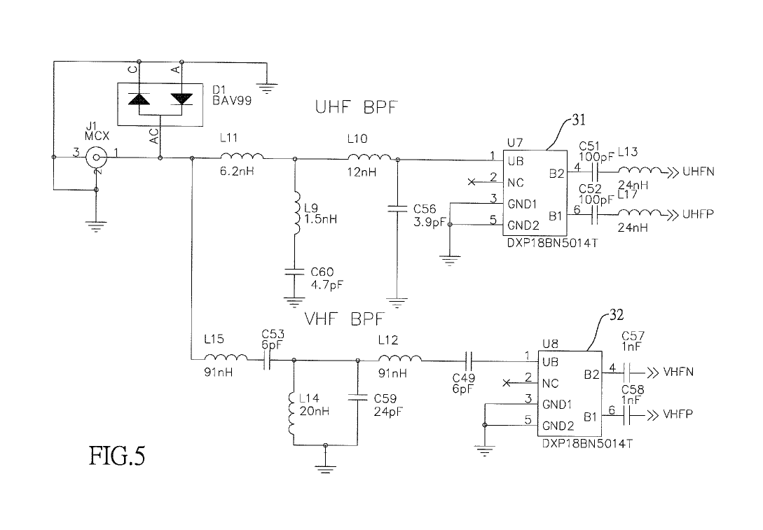

With reference to FIG. 5, the RF receiving module 30 is composed of two digital signal tuners 31, 32 and two sets of matching passive components. An input terminal UB of the digital signal tuner 31 is connected to the antenna port 12 through one set of matching inductors (L9, L10, L11) and capacitors (C56, C60). An input terminal UB of the digital signal tuner 32 is connected to the antenna port 12 through the other set of matching inductors (L12, L14, L15) and capacitors (C53, C59). The digital signal tuners 31, 32 respectively have a set of VHF output terminals (VHFP, VHFN) and a set of UHF output terminals (UHFP, UHFN). The set of VHF output terminals (VHFP, VHFN) is connected to the set of RF signal input terminals (VHFP, VHFN) of the digital TV processor 20. The set of UHF output terminals (UHFP, UHFN) is connected to the other set of RF signal input terminals (UHFP, UHFN) of the digital TV processor 20.

The UHF digital signals of the RF receiving module 30 are obtained by the use of resonance of the set of matching inductors (L9, L10, L11) and capacitors (C56, C60). The VHF digital signals of the RF receiving module 30 are obtained by the use of resonance of the other set of matching inductors (L12, L14, L15) and capacitors (C49, C53, C59). The unbalanced signals of the UHF digital signals and the VHF digital signals are respectively converted into balanced signals by the digital signal tuners 31, 32 and the balanced signals are respectively outputted to the two sets of RF signal input terminals (UHFP, UHFN, VHFP, VHFN) of the digital signal processor 20.

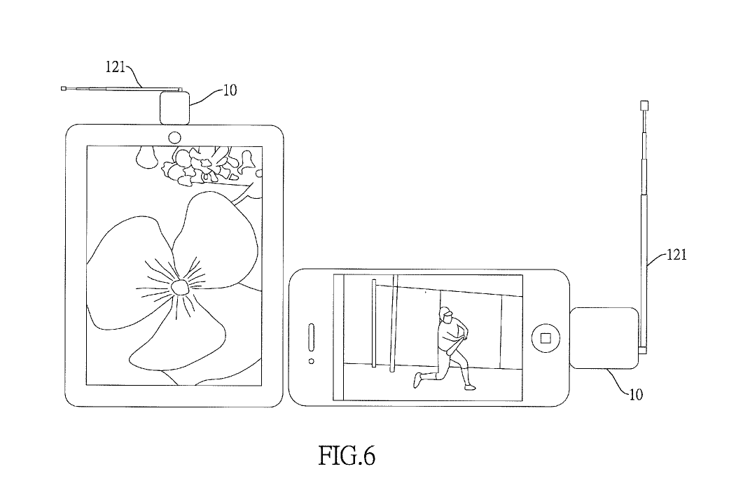

With reference to FIG. 6, the connector 11 on the body 10 of the digital TV receiver is electrically connected with a socket of a handheld device, and the antenna port 12 of the digital TV receiver is plugged in by an antenna 121 capable of receiving digital signals. A 3.3V operating voltage for the handheld device can be acquired through the power input pin (VCC3.3C) of the connector 11. The 3.3V operating voltage is further converted to an operating voltage (1.8V, 1.2V) for operating the digital TV processor 20 through the switching power conversion module 60. The authentication chip 40 and the memory 50 storing authentication data transmit authentication data to a handheld device for acquisition of an authentication approval issued by the handheld device through the set of authentication data access terminals (HSGD, HGSCLK) and the set of signal access terminals (USB_DN, USB_DP). After the handheld device sends out the authentication approval, the two sets of RF signal input terminals (UHFP, UHFN, VHFP, VHFN) of the digital TV processor 20 acquire digital signals received from the antenna 121. The received digital signals are decoded and encoded to video data by the digital TV processor 20, and the video data are sent to the signal access pins 4, 6 of the connector 11 through the set of signal access terminals (USB_DN, USB_DP) and are further sent to the handheld device for the handheld device to display the video data.

With the foregoing design, the batteryless digital TV receiver allows users to watch digital TV programs on handheld devices after connected with the handheld devices. Meanwhile, the batteryless digital TV receiver can acquire operating power, which is approximately 97 mA, and also meets strict power requirement, which is less than 100 mA.

Apple Inc. also has other operation requirements associated with a low power mode, such as a state when a digital TV receiver is plugged in a handheld device but no software program is started, or after the digital TV receiver is plugged in a handheld device, software is running but no digital TV program is shown on the handheld device. The operation requirements at the low power mode specify that the current consumption must be less than 10 mA. Therefore, in the present embodiment, when the digital TV receiver is electrically connected with a handheld device, the communication interface between the digital TV receiver and the handheld device is a Universal Asynchronous Receiver/Transmitter (UART) interface. The digital TV receiver can be switched to a low power mode through the UART interface and the consumed current is less than 5 mA. When the software of the handheld device is started and digital TV programs are shown on the handheld device, the digital TV receiver can be switched to a normal power mode through the UART interface and the consumed current is about 97 mA. Moreover, when the antenna 121 of the digital TV receiver fails to receive digital TV signals or the software of the handheld device is terminated, the digital TV receiver can be switched to the low power mode through the UART interface so as to make power management more efficient.

With further reference to FIG. 1, the body 10 of the digital TV receiver further has a power port 13 thereon. With further reference to FIG. 3, the power port 13 is a Micro USB interface and has a power pin (VBUS). The power pin (VBUS) supplies DC power (USB5.0V) and also provides a charging signal (Charger ON) to the digital TV processor 20 for the digital TV processor 20 to determine if power is inputted from the power port 13 to charge the handheld device.

In the present embodiment, the power pin (VBUS) of the power port 13 is further connected to a power output terminal (5.0V) of the connector 11 through a protection module 70 to prevent over-voltage or over-current occurring when power is outputted through the power port 13 from damaging the handheld device. With further reference to FIG. 4, the protection module 70 has a detection device 71, an electronic switch 73 and a power supply device 72. The detection device 71 is used to connect to the power pin (VBUS) of the power port 13, detect if the DC power (USB5.0V) inputted through the power port 13 exceeds a rated voltage or current, and determine if the electronic switch 73 is switched on. In the present embodiment, the electronic switch 73 is formed by an enhancement type NMOS (N-channel MOSFET), the gate of the enhancement type NMOS is connected to an output terminal of the detection device 71, and the drain is connected to an Enable/Fault terminal of the power supply device 72. The power supply device 72 has an input terminal connected to the power pin (VBUS) of the power port 13 and an output terminal connected to the power output pin of the connector 11, and converts the DC power (USB5.0V) inputted through the power port 13 and then outputs the converted power to the connector 11 so as to charge the handheld device through the connector 11. If the detection device 71 detects that the inputted DC power (USB5.0V) is faulty, the electronic switch 73 connects voltage of the power pin (VBUS) of the power port 13 to ground. Otherwise, the DC power (USB5.0V) is outputted to the power supply device 72 and the power supply device 72 outputs a stable voltage to the power output pin (5.0V) of the connector 11 to charge the handheld device. When a power supply is available, a handheld device can be charged through the digital TV receiver to acquire sufficient power for operation upon displaying digital TV programs.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A batteryless digital television (TV) receiver comprising:
a body;
a connector mounted on the body and having a power input pin and a set of signal access pins;
an antenna port mounted on the body;
a digital TV processor having:
at least one power input terminal;
one set of signal access terminals connected to the set of signal access pin of the connector;
a set of authentication data access terminals; and
at least one set of radio frequency (RF) signal input terminals;
an RF receiving module having:
at least one set of digital signal input terminals connected to the antenna port on the body;
at least one set of digital signal output terminals respectively connected to the at least one set of RF signal input terminals of the digital TV processor; and
a power input terminal;
an authentication chip having:
a set of authentication data access terminals connected to the set of authentication data access terminals of the digital TV processor; and
a power input terminal;
a switching power conversion module having:
at least one power input terminal connected to the power input pin of the connector; and
multiple power output terminals respectively connected to the power input terminals of the digital TV processor, the RF receiving module and the authentication chip;
wherein the digital TV receiver, the RF receiving module, the authentication chip and the switching power conversion module are mounted inside the body.

2. The batteryless digital TV receiver as claimed in claim 1, wherein the switching power conversion module has a first switching power converter and a second switching power converter, each of the first switching power converter and the second switching power converter has a power input terminal connected to the power input pin of the connector.

3. The batteryless digital TV receiver as claimed in claim 2, wherein the RF receiving module has:
two digital signal tuners respectively having:
a set of very high frequency (VHF) output terminals; and
a set of ultra high frequency (UHF) output terminals; and
two sets of matching inductors and capacitors, wherein each digital signal tuner has an input terminal connected to the antenna port on the body through one of the two sets of matching inductors and capacitors.

4. The batteryless digital TV receiver as claimed in claim 3, wherein the digital TV processor converts and generates digital TV signals and has two sets of RF signal input terminals respectively connected to the set of VHF output terminals and the set of UHF output terminals to receive VHF and UHF digital TV signals.

5. The batteryless digital TV receiver as claimed in claim 4 further comprising a memory mounted inside the body and having a set of authentication data access terminals connected to the set of authentication data access terminals of the digital TV processor.

6. The batteryless digital TV receiver as claimed in claim 5, wherein the digital TV receiver has a universal asynchronous receiver-transmitter (UART) interface adapted to interface with a handheld device.

7. The batteryless digital TV receiver as claimed in claim 1, wherein
the body has a power port thereon having a power pin; and
the connector has a power output pin connected to the power pin of the power port of the body.

8. The batteryless digital TV receiver as claimed in claim 2, wherein
the body has a power port thereon having a power pin; and
the connector has a power output pin connected to the power pin of the power port of the body.

9. The batteryless digital TV receiver as claimed in claim 3, wherein
the body has a power port thereon having a power pin; and
the connector has a power output pin connected to the power pin of the power port of the body.

10. The batteryless digital TV receiver as claimed in claim 7, wherein
the power pin of the power output is connected to the power output pin of the connector through a protection module;
the protection module has:
a power supply device having:
an input terminal connected to the power pin of the power port;
an output terminal connected to the power output pin of the connector; and
an enable terminal;
an electronic switch; and
a detection device connected to the power pin of the power port, detecting if a DC power inputted through the power port exceeds a rated voltage, determining if the power supply device supplies power through the electronic switch, and having an output terminal.

11. The batteryless digital TV receiver as claimed in claim 8, wherein
the power pin of the power output is connected to the power output pin of the connector through a protection module;
the protection module has:
a power supply device having:
an input terminal connected to the power pin of the power port;
an output terminal connected to the power output pin of the connector; and
an enable terminal;
an electronic switch; and
a detection device connected to the power pin of the power port, detecting if a DC power inputted through the power port exceeds a rated voltage, determining if the power supply device supplies power through the electronic switch, and having an output terminal.

12. The batteryless digital TV receiver as claimed in claim 9, wherein
the power pin of the power output is connected to the power output pin of the connector through a protection module;
the protection module has:
a power supply device having:
an input terminal connected to the power pin of the power port;
an output terminal connected to the power output pin of the connector; and
an enable terminal;
an electronic switch; and
a detection device connected to the power pin of the power port, detecting if a DC power inputted through the power port exceeds a rated voltage, determining if the power supply device supplies power through the electronic switch, and having an output terminal.

13. The batteryless digital TV receiver as claimed in claim 10, wherein the electronic switch is formed by an enhancement type NMOS (N-channel MOSFET), a gate of the enhancement type NMOS is connected to the output terminal of the detection device, and a drain is connected to the enable terminal of the power supply device.

14. The batteryless digital TV receiver as claimed in claim 11, wherein the electronic switch is formed by an enhancement type NMOS, a gate of the enhancement type NMOS is connected to the output terminal of the detection device, and a drain is connected to the enable terminal of the power supply device.

15. The batteryless digital TV receiver as claimed in claim 12, wherein the electronic switch is formed by an enhancement type NMOS, a gate of the enhancement type NMOS is connected to the output terminal of the detection device, and a drain is connected to the enable terminal of the power supply device.

16. The batteryless digital TV receiver as claimed in claim 13, wherein the power port is a Micro USB interface.

17. The batteryless digital TV receiver as claimed in claim 14, wherein the power port is a Micro USB interface.

18. The batteryless digital TV receiver as claimed in claim 15, wherein the power port is a Micro USB interface.
